(19) United States
(12) Patent Application Publication
(10) Pub. No.: US 2026/0170981 A1
(43) Pub. Date: Jun. 18, 2026

(54) METHOD FOR DIAGNOSING FAULTS IN A FIELD DEVICE AND FIELD DEVICE

(71) Applicant: Endress+Hauser Conducta GmbH+Co. KG, Gerlingen (DE)

(72) Inventors: Martin Lohmann, Gerlingen (DE); Stefan Robl, Hünxe (DE); Thomas Alber, Stuttgart (DE); Tetyana P'yatak, Aalen (DE); Daniela Haider, Stuttgart (DE); Florian Harmuth, Remseck am Neckar (DE)

(21) Appl. No.: 19/419,360

(22) Filed: Dec. 15, 2025

(30) Foreign Application Priority Data
Dec. 18, 2024 (DE) 10 2024 138 674.6

(51) Int. Cl. G09G 3/00

(52) U.S. Cl. CPC G09G 3/006; G09G 2370/06

(57) ABSTRACT

A method for diagnosing a field device in the event of an error comprises providing the field device, including a base module, an edge device, and a data diode arranged between the base module and the edge device in the data flow. The edge device is designed to send data from the base module to a cloud. The method further includes checking the data flow direction in the data diode; providing a data connection from the edge device to the base module; making a diagnosis in the event of a fault, creating diagnostic information, in particular a logbook, and sending the diagnostic information from the edge device to the base module; terminating the data connection between the edge device and the base module; evaluating the diagnostic information; and deriving measures to eliminate the fault. Further disclosed is a field device for executing the method.

### CROSS-REFERENCE TO RELATED APPLICATION

The present application is related to and claims the priority benefit of German Patent Application No. 10 2024 138 674.6, filed on Dec. 18, 2024, the entire contents of which are incorporated herein by reference.

### TECHNICAL FIELD

The present disclosure relates to a method for diagnosing faults in a field device and to a field device.

### BACKGROUND

In order to optimize process flows and the planning of maintenance tasks, data from process-and production-related devices is increasingly being transferred to other processing systems in industry, independently of the process control system. One such processing system is a so-called “maintenance +optimization” system (M+O). In process automation, devices from the field level (“field devices”) are connected to cloud systems for this purpose. This is a connection from the previously closed control area, also termed “core process control” (CPC), to spatially and functionally remote M+O systems.

The connection is made via an edge device, also called an edge module. An edge device is a linking device between the field device and a server or a server platform in the cloud. The edge device is the network element that is responsible for connecting the LAN network (“local area network”) with an external WAN network (“wide area network”) so that all data is available anytime and anywhere. The edge device is responsible for providing the local information to an external network. It translates between different protocols if necessary and establishes the connection between the two network boundaries.

This potentially poses a security threat. In order to ensure that the M+O systems are free of repercussions on the CPC level, NAMUR has therefore described the so-called NOA concept (“NAMUR open architecture”) in Namur Recommendation 175, in which a so-called data diode only ensures the data transmission from the CPC in the M+O direction. In this context, one speaks of a data diode, NOA diode or NAMUR diode. The data diode therefore ensures secure, unidirectional data transmission from the field devices in the direction of the cloud without any impact on the process. An edge device with an integrated data diode therefore meets the NOA objective according to which data are to be made “easily and reliably useful for system and device monitoring and optimization”. For IT security reasons, automation components should only send data unidirectionally (via the data diode) over the communication channel, but not receive it.

For cost and space reasons, the edge device often does not have its own display other than status LEDs.

Designs of the edge device include an option for controlled bridging of the data diode in order to be able to transfer data from the cloud to the field device if required. However, this is only possible for applications whose security requirements allow this bidirectional data transfer. The bridging can be implemented by means of a software-controlled electronic switch, by means of a mechanical switch (slide switch, DIP switch, jumper, etc.) or by a series connection of these options.

In applications with high safety requirements, the data diode is always active and only unidirectional data transmission from the CPC to the M+O level is possible. If an error occurs on the edge device, a status LED on the edge device may light up or flash, but no detailed information can be transmitted to the field device.

The situation becomes more serious if the error lies in the connection to the cloud since no information from the edge device arrives on the cloud system either.

While an on-site service employee can see the status LED of the edge device, they have no easy way to determine details about the problem's cause and resolution.

### SUMMARY

The present disclosure is based on the object of providing a service employee on site with error details without impairing the safety function of the data diode.

The object is achieved by a method for diagnosing a field device in the event of a fault, comprising the steps of providing a field device, wherein the field device comprises a base module and an edge device, wherein a data diode is arranged between the base module and the edge device in the data flow, wherein the edge device is designed to send data from the base module to a cloud; checking the data flow direction in the diode; providing a data connection from the edge device to the base module; making a diagnosis in the event of a fault, creating diagnostic information, in particular a logbook, and sending the diagnostic information from the edge device to the base module; terminating the data connection between the edge device and the base module; evaluating the diagnostic information; and deriving measures for eliminating the fault.

The data diode is located in the data flow between the base module and the edge device and therefore allows data to pass in only one direction during normal operation. In the event of a fault, it is first checked whether this is actually the case. If this is the case, a user action will temporarily enable a data connection in the opposite direction. Diagnostic information, such as a logbook, is transmitted, with which a diagnosis of the cause of the error can be created. The short-term data connection will then be disconnected again. The user action can take place either locally on the field device or via fieldbus communication from the secure CPC area.

One embodiment provides that only the diagnostic information is transmitted. No executable code or other data qualities or other data connections are transmitted or accepted by the field device.

One embodiment provides that a mechanical switch is closed to provide a data connection from the edge device to the base module.

In the case of the mechanical switch, the detection of whether or not the data direction is unidirectional can be realized, for example, by a 2-pole design, which allows the field device to check in which position the switch is. Alternatively, the edge device can also cyclically send a test telegram or so-called “keep-alive” message to the field device. If this does not occur, the field device can infer an interruption - and therefore unidirectional operation.

One embodiment provides that the provision of a data connection from the edge device to the base module is software-controlled. This design therefore provides that the edge device and/or the base module has a software-implemented “switch” that prevents/allows the sending or processing of data and therefore forms the data diode.

In one embodiment, the software-controlled “switch” is opened or closed via a fieldbus command. This means that a service employee does not have to be on site to close the switch.

In one embodiment, the software-controlled “switch” is influenced by user interaction with the field device (from the safe area, i.e. the base module).

One embodiment provides that an electronically controlled switch is closed to provide a data connection from the edge device to the base module. The opening and closing of this electronically controlled switch is software controlled. The electronically controlled switch is just as safe in terms of security as the mechanical switch because it is only controlled from the safe area by the field device directly (i.e. the base module). The edge device has no influence on this, or an influence from “outside” is excluded.

In one embodiment, the electronically controlled switch is opened or closed via a fieldbus command. This means that a service employee does not have to go to the field device to close the switch.

In one embodiment, the electronically controlled switch is influenced by user interaction with the field device (from the safe area, i.e. the base module).

There are three options for temporarily providing a data channel from the edge device to the base module, which can also be connected in series if necessary, namely, the software-controlled actuation of a “switch” and the hardware-controlled actuation of a switch, be it as a mechanical switch or as an electronically controlled switch. In particular, the combination of the mechanical switch with the software “switch” is advantageous in this case.

One embodiment provides that before the step “Checking the data flow direction in the data diode”, the following step is carried out: Terminating the connection between the edge device and the cloud.

One embodiment provides that after the step “Terminating the data connection between the edge device and the base module”, the following step is carried out: Re-establishing the connection between the edge device and the cloud.

One embodiment provides that in the event of a fault, data from the field device and/or devices connected thereto are collected and/or processed by the edge device over a period of time and transmitted when a connection is re-established, preferably with a time stamp.

One embodiment provides for a user to be guided through the individual steps by means of a wizard. In one embodiment, this is carried out by a state machine. A “wizard” is a support by means of which a user is automatically guided through one or more dialogs. Depending upon the answer to a first question, the user is asked a respective second question or provided with other answers. In this way, the user can, for example, be guided by means of step-by-step instructions.

One embodiment provides that the transmitted diagnostic information, i.e. the transmitted logbook, is displayed by the field device.

The object is further achieved by a field device for carrying out a method as described above, comprising a base module; an edge device; and a data diode that is arranged in the data flow between the base module and the edge device.

One embodiment provides that the field device is designed as a measuring transducer, and the edge device is designed as a plug-in module therefor.

One embodiment provides that the edge device comprises a mechanical switch that forms the data diode.

One embodiment provides that the edge device comprises an electronically controlled switch, in particular an electronic switch, such as a digital gate, relay, circuits with field-effect transistors or diodes, etc., which is actuated by the base module via software and which forms the data diode, and which is closed to provide a data connection from the edge device to the base module.

One embodiment provides that the field device comprises a display. The diagnostic information, i.e. the logbook, can be displayed on the display. This is beneficial for the user on site.

One embodiment provides that the field device comprises one or more control elements. The user can interact via the control elements and/or via the display (particularly in the touch display design), for example, the software-controlled “switch” or the electronically controlled switch can be opened or closed thereby.

Alternatively or additionally, in one embodiment, the diagnostic information is sent via a fieldbus protocol of the measuring transducer. In one embodiment, the diagnostic information is sent to a mobile device, for example via Bluetooth. In one embodiment, the measuring transducer, specifically the base module, comprises an SD card slot, and the diagnostic information is loaded onto an SD card for further processing.

### BRIEF DESCRIPTION OF THE DRAWINGS

This is explained in more detail with reference to the following figures.

FIG. 1 shows a symbolic measuring system.

FIG. 2 shows a claimed measurement measuring transducer in a measuring system.

### DETAILED DESCRIPTION

In the figures, the same features are labeled with the same reference signs.

A field device is designed as a measuring transducer 1 in the figures.

First, the measuring transducer 1 and its embedding in a measuring system 200 will be discussed.

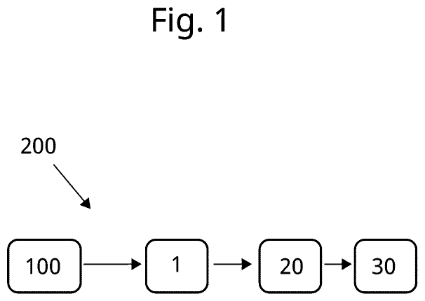

FIG. 1 shows a measuring system 200 with four subsystems, specifically a sensor 100, a measuring transducer 1, an edge device 20, and a cloud 30. A measuring system 200 with more or fewer than four subsystems is possible.

In FIG. 1, the embodiment with a measuring transducer 1 and a separate edge device 20 is depicted.

In general, an edge device 20 is a linking device between the internal domain of the process owner - here the owner or user of the sensor 100 and the measuring transducer 1 - and the external domain, i.e. the Internet and the cloud 30. The edge device 20 collects, for example, time-stamped measurement data from the sensor 100, processes and/or transmits it to a server platform or a remote server in the cloud 30. In one embodiment, the edge device 20 is arranged remotely from the sensor 100/measuring transducer 1 and has a first data interface for communication with the measuring transducer 1 and a second data interface for communication with the server or the server platform. The communication between the measuring transducer 1 - and possibly other field devices - and the edge device 20 is based, for example, on the HART protocol or another protocol that is used in process automation applications. However, the data can also be transmitted via other standardized protocols, such as Bluetooth and the like. The communication between the edge device 20 and the server platform/server in the cloud 30 is preferably based on a standard Internet protocol. Communication can be wired or wireless.

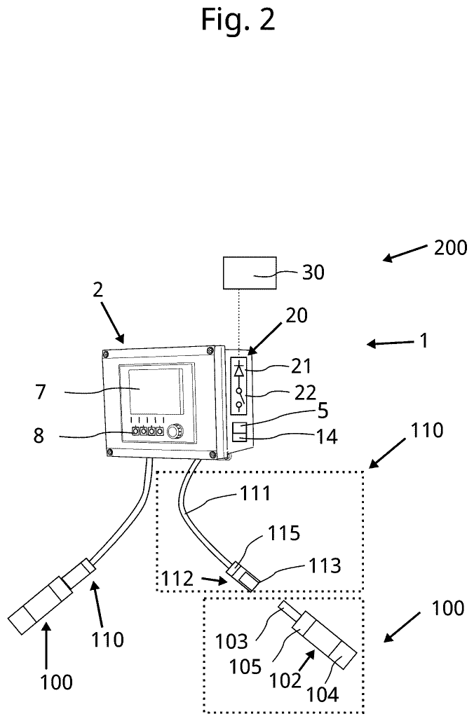

However, the edge device 20 can also be part of the measuring transducer 1. This is shown in FIG. 2. Then the edge device 20 is designed as a plug-in module for the measuring transducer 1 (see below).

The measuring system 200 is coordinated with the sensor 100, measuring transducer 1, edge device 20 and the cloud 30 to monitor a process of process automation technology, to display the measured values, for example, on the on-site display 7 of the measuring transducer 1, to transmit the measured values from the measuring transducer 1 via the edge device 20 to the cloud 30 and to display them there.

Generally speaking, the measuring transducer 1, also called a transmitter, is a device that converts an input variable into an output variable according to a fixed relationship. In process automation technology, a field device, for example, is connected to a measuring transducer. “Measuring transducer” and “transmitter” are used synonymously herein. The field device is a sensor, for example. Its raw measured values are processed in the measuring transducer, e.g., averaged or converted by means of a computation model to another variable—for example, the process variable to be determined—and possibly transmitted—to a control system, for example.

A wide variety of sensors can be connected to the measuring transducer 1. Under the aforementioned name, “Memosens,” the applicant markets sensors for measuring pH value, conductivity, oxygen, turbidity, and other things. The measuring transducer can also be an integral part of the sensor.

In FIG. 2, the measuring transducer 1 is connected to the sensor 100 via a cable 111. The raw measured values of the sensor 100 are processed in the measuring transducer 1, e.g., averaged an/or converted by means of a computation model to another variable-for example, the process variable to be determined-and possibly transmitted-to a control system, for example. The measuring transducer 1 comprises a data processing unit 14 with a memory 5.

The sensor 100 comprises a first physical interface 103 via which the sensor 100 is connected to the measuring transducer 1 and thereby exchanges data (bidirectionally) and is supplied with energy (unidirectionally). The cable 111 is part of a connection element 110 which can be connected at one end to the measuring transducer 1 and at the other end to the sensor 100. At the sensor-side end, the cable 111 has a second physical interface 113 complementary to the first physical interface 103. The physical interfaces 103, 113 are designed for instance as electrically isolated-especially, inductive-interfaces. The physical interfaces 103, 113 can be coupled to each other by means of a mechanical plug connection. The mechanical plug connection is hermetically sealed, such that no fluid, such as the medium to be measured, air, or dust can enter from the outside.

The sensor 100 comprises at least one sensor element 104 for detecting a measurand of process automation. The sensor 100 is then for example a pH sensor, also known as ISFET, generally an ion-selective sensor, a sensor for measuring the redox potential, from the absorption of electromagnetic waves in the medium, for example with wavelengths in the UV, IR and/or visible ranges, of oxygen, conductivity, turbidity, the concentration of non-metallic materials, or temperature with the particular measurand.

The sensor 100 further comprises a first coupling body 102, which comprises the first physical interface 103. The connection element 110 comprises a second, cylindrical coupling body 112 that is designed to be complementary to the first coupling body 102 and can be slipped with a sleeve-like end portion onto the first coupling body 102, wherein the second physical interface 113 is plugged into the first physical interface 103.

The sensor 100 comprises a data processing unit 105, such as a microcontroller, which processes the raw values of the measurand obtained by the detection hardware integrated into the sensor 100 and, for example, converts them into a different data format. The data processing unit 105 is designed for energy and space reasons to usually be rather small or economical with respect to the computing capacity and the memory volume. It is therefore often only intended for “simple” computing operations-for example, for digital conversion, pre-processing, and averaging. The data processing unit 105 converts the value that depends on the measurand (i.e., the measurement signal of the sensor element 104) into a protocol that the measuring transducer 1 can understand.

The connection element 110 can comprise a data processing unit 115. The data processing unit 105 is designed to be “small” and can serve as a repeater for the data.

Several sensors 100 can also be connected to a measuring transducer 1. Shown in FIG. 2 are two sensors 100, wherein only one of the two is provided with all of the reference signs. The same or different sensors can be connected. The left-hand one of the two is shown in the plugged-in state. Up to eight sensors can be connected to the measuring transducer 1, for example.

The measuring transducer 1 can be connected to a superordinate unit, such as a control system, via a cable. The measuring transducer 1 forwards the measurement data to a control system. In this case, the control system is designed as a process control system (PLC), PC, or server. For this purpose, the measuring transducer 1 transmits the data via a communication protocol that the control system can understand, for example a fieldbus, such as HART, Profibus PA, Profibus DP, Foundation Fieldbus, Modbus RS485, or also an Ethernet-based fieldbus, such as EtherNet/IP, PROFINET, or Modbus/TCP. This case is not shown here. Additionally or alternatively, the data is transferred to the cloud 30.

The measuring transducer 1 comprises a display 7 and one or more operating elements 8, e.g., knobs or rotary knobs, buttons or soft keys, via which the measuring transducer 1 can be operated. Measured data, for example, of the sensor 100 are displayed by the display 7. The sensor 100 can also be configured and parameterized by means of the operating elements 8 and the corresponding view on the display 7. The display 7 can also be designed as a touch display; the operating elements 8 can then also be part of the touch display, viz., as touch operating elements. The measuring transducer 1 comprises the data processing unit 14.

In this embodiment, the measuring transducer 1 comprises the edge device 20. The edge device 20, for example, is designed as a plug-in module for the measuring transducer 1. Data are forwarded to the cloud 30 via the edge device 20. The edge device 20 comprises one or more wireless modules for mobile communications (2G, 3G, 4G, 5G, . . . ). The edge device 20 comprises an antenna which, in one embodiment, is located within the housing of the measuring transducer 1.

In addition, the measuring transducer 1 can comprise one or more additional wireless modules, for example for Bluetooth or WirelessHART.

In general, the measuring transducer 1 comprises a base module 2 and one or more additional modules. One of these additional modules is the edge device 20. Using such modules, the measuring transducer 1 can be expanded so that more than one or two sensors (as shown) can be connected (see above). The base module 2 comprises, for example, the data processing unit 14 and the memory 5 as well as the power supply. Furthermore, the basic module 2 comprises the interfaces to the various fieldbuses (see above).

The measuring transducer 1 or the sensors 100 connected thereto can be operated and parameterized via the control elements 8. To this end, a menu or the menu structure is shown on the display 7. The menu structure describes the hierarchy, navigation, and texts of the various menu pages that are shown on the display 7. The menu structure makes it possible to select the desired command from an offering and to have it executed.

The edge device 20 comprises a data diode 21. With the data diode 21, it is ensured that during normal operation, only data from the measuring transducer 1 (via the edge device 20) can be sent to the cloud 30 and not vice versa. The data diode 21 is “set” to unidirectional during normal operation because the user does not allow an Internet connection to the measuring system 200.

In the event of a fault, the data diode 21 can be temporarily “bridged” or, in other words:
In the event of a fault, a data connection can also be established from the edge device 20 to the base module 2. There are various options for this:

Via a software-controlled “switch”.

Via a mechanical switch 22 which is operated locally.

Via an electronically controlled switch 22 which is switched by software control - namely from the base module 2. The measuring transducer 1 is connected to a fieldbus via the base module 2 (see above). The electronically controlled switch 22 can therefore be switched via a command via a fieldbus protocol (Profibus PA, Profibus DP, Foundation Fieldbus, Modbus RS485, EtherNet/IP, PROFINET or Modbus/TCP).

The edge device 20 also provides a diagnostic signal via which it can also electrically communicate its status to the measuring transducer 1. By means of the diagnostic signal, the user is given the option of detecting a fault when they are not on site, for example via the fieldbus, an alarm relay, a fault current, etc. The diagnostic signal can for example be coded as follows:
Off->everything OK; On->error
Off->major error, e.g., hardware defect; On->everything OK; “Alternating” >Edge device is working, diagnostic information is available
or variations thereof.

The edge device 20 comprises one or more status LEDs to communicate its status to the human observer. The status LED is helpful for the user on site. The electrical diagnostic signal can also be reproduced via this status LED for visual signaling to the user on site, for example in the manner described above.

For example, the following incidents could occur in the measuring system 200:
Overvoltage from lightning damages the radio module or the network connection
Animals damage one or more cables, for example the antenna cable or a network cable, or the antenna
Antenna or network infrastructure damaged by vandalism
Expired certificate of the edge device 20
Incorrect IP configuration of the edge device 20
Hacking attack on the edge device 20
etc.

The edge device 20 can detect the fault state, i.e. that there is no connection to the cloud 30, and sets the status LED and the electrical diagnostic signal to the fault state. An edge device error is displayed on the field device, i.e. on the measuring transducer 1, which however only indicates a general problem with the edge device, but not, however, the exact cause.

The edge device may now display the diagnostics for the error in the cloud. However, in the above-mentioned incidents, there is no connection to the cloud, and nothing is transferred.

It is difficult for an on-site service employee to determine the cause. Transporting the entire measuring site to the workshop for closer examination is usually not an option either. Switching the data diode to bidirectional communication mode is often not an option either due to cyber threats.

The measuring transducer 1 now offers a wizard for the secure transfer of diagnostic information, for example a logbook, with diagnostic data from the edge device 20 to the measuring transducer 1.

The term “wizard” describes an interface, by means of which a user is guided through several dialogs for an ergonomic data input. Assistance is provided to simplify the execution of certain steps, in this case for the secure transfer of diagnostic data.

The following steps are executed:
1. Start wizard on the measuring transducer 1.
2. The edge device 20 is informed by the measuring transducer 1 that the wizard has been started.
3. The wizard checks the direction of data flow in the data diode 21; in other words, it checks whether the software switch, the mechanical switch and/or the electronically controlled switch is open or closed. For example, the following dialogs could appear on the display 7, which the user must correspondingly confirm or perform the required steps:
a. “To transmit the diagnostic data, the software switch is briefly closed. ESC/Continue?”
b. “Please close the hardware switch to transmit diagnostic data. ESC/Continue?”
4. Now only the diagnostic logbook is transmitted as a data packet. No executable code or other data qualities or other data connections are transmitted or accepted by the field device.
5. The software and/or hardware switches are then switched back to the safe state automatically or by the user. The following messages can be displayed:
a. “The software switch has been reset to its original state.”
b. “Please reopen the hardware switch.”
6. The transferred diagnostic logbook from the edge device 20 can now be checked and evaluated in measuring transducer 1.
7. The edge device 20 is informed by the measuring transducer 1 that the wizard has ended.
8. Display of information:
a. Normally, the diagnostic information of the edge device is displayed, for example:
“Weak transmission power, please check antenna”
“No IP connection, please check settings or start setup wizard.”
“Expired certificate. Please upload a current certificate.”

Accordingly, with these error details, the underlying problem (replacement antenna, cable, etc.) can be solved.
b. If the edge device has been hacked, the diagnostic log can contain incorrect or missing entries. This is an indication of a hacker attack for the service employee, and he can take appropriate measures.

To increase security, the edge device 20 can use wizard steps “2.” and “7.” to interrupt or resume the Internet connection during temporary communication between the edge device 20 and the base module 2 so that at no time is there a continuous connection between the Internet (cloud 30) and the measuring transducer 1.

This document describes a security wizard for the guided secure transmission of diagnostic information from an edge device 20 with a data diode 21. This is done by temporarily, deliberately and remotely switching open the data diode 21 for diagnostic purposes. In addition, the error status is signaled, for example, via an alternating signal and/or a status LED.

1. A method for diagnosing a field device in an event of a fault, the method comprising:
providing the field device, including:
a base module;
an edge device; and
a data diode arranged between the base module and the edge device in a data flow,
wherein the edge device is designed to send data from the base module to a cloud;
checking a data flow direction in the data diode;
providing a data connection from the edge device to the base module;
making a diagnosis in the event of the fault, including creating diagnostic information and sending the diagnostic information from the edge device to the base module;
terminating the data connection between the edge device and the base module;
evaluating the diagnostic information; and
deriving measures to eliminate the fault.

2. The method according to claim 1,
wherein only the diagnostic information is transmitted.

3. The method according to claim 1,
wherein a mechanical switch is closed to provide the data connection from the edge device to the base module.

4. The method according to claim 1,
wherein the provision of the data connection from the edge device to the base module is software-controlled.

5. The method according to claim 1,
wherein an electronically controlled switch is closed to provide the data connection from the edge device to the base module.

6. The method according to claim 1,
wherein before the step “checking the data flow direction in the data diode”, the method further comprises:
terminating the connection between the edge device and the cloud.

7. The method according to claim 1,
wherein after the step “terminating the data connection between edge device and base module”, the method further comprises:
re-establishing the connection between the edge device and the cloud.

8. The method according to claim 1, wherein a user is guided through the individual steps using a wizard.

9. The method according to claim 1, wherein the diagnostic information is displayed by the field device.

10. A field device for executing a method according to claim 1, the field device comprising:
a base module;
an edge device; and
a data diode that is arranged in a data flow between the base module and the edge device.

11. The field device according to claim 10,
wherein the field device is designed as a measuring transducer, and the edge device is designed as a plug-in module therefor.

12. The field device according to claim 10,
wherein the edge device includes a mechanical switch that forms the data diode.

13. The field device according to claim 10,
wherein the edge device includes an electronically controlled switch actuated by the base module via software and forms the data diode, and is closed to provide a data connection from the edge device to the base module.

14. The field device according to claim 10, further comprising:
a display.
